(19) United States
(12) Patent Application Publication
(10) Pub. No.: US 2018/0031485 A1
(43) Pub. Date: Feb. 1, 2018

(54) DISTRIBUTED FIBER OPTIC CHEMICAL SENSOR AND METHOD

(71) Applicant: Intelligent Optical Systems, Inc., Torrance, CA (US)

(72) Inventors: Jesus Delgado Alonso, Torrance, CA (US); Narciso Guzman, Torrance, CA (US); David Berry, Torrance, CA (US)

(21) Appl. No.: 15/607,218

(22) Filed: May 26, 2017

Related U.S. Application Data
(60) Provisional application No. 62/368,793, filed on Jul. 29, 2016.

(51) Int. Cl. G01N 21/77

(52) U.S. Cl. CPC G01N 21/7703; G01N 2021/7716

(57) ABSTRACT

Disclosed is a design for distributed optic fiber sensors and a corresponding method for sensing chemical concentrations with distributed fiber optic sensors, which utilizes segments of optical fiber which incorporate multiple sensing locations along the fiber. The distributed sensors incorporated into the optic fiber generate signals which are simultaneously detected and combined to produce a resultant signal with the effective optic fiber sensor length equal to that of the corresponding fiber segment.

### RELATED APPLICATIONS

This application for patent claims the benefit of provisional application 62/368,793, filed on Jul. 29, 2016. The application is incorporated herein in its entirety.

### GOVERNMENT LICENSE RIGHTS

This invention was made with government support under contract # DE-SC0013240 awarded by the Department of Energy. The government has certain rights in the invention.

### FIELD OF THE INVENTION

This field of this disclosure relates generally to chemical sensors.

### BACKGROUND

Fiber optic chemical sensor systems generally comprise a light source, optic fiber(s), a detector sensor, optical filters, analog signal amplifiers, and signal processing hardware and software. Optical radiation of the wavelength or range selected by an optical filter is directed into the core of the optical fiber. The waveguide (optic fiber) carries the optical radiation (light) to the sensor material (generally affixed or located at a tip at the end of the optical guide). The sensor material typically comprises as its active component a suitable amount of a specific indicator chemical compound or molecule which is immobilized onto a polymer substrate. The absorption of the light by the indicator molecule may result in a variation of the light intensity at a particular wavelength (when a colorimetric indicator dye is used), or in the emission of light at a different wavelength, when a fluorometric chemistry is selected.

The modified light is guided back through the optical fiber to a photodetector. Upon a (selective) interaction with the target analyte species, the reagent material undergoes a measurable change in its optical properties (absorption and/or emission), which is reflected in a variation in the light detected by the photodetector. The resulting electrical signal is amplified and eventually digitized for final processing. Calibration with standard samples before sensor installation allows continuous in situ measurement of the target chemical species, as long as the sensor-analyte interaction is reversible. In the case of biosensors, a biological sensing element is combined with an optical chemical sensor as transducer. The biological sensing element interacts with the target analyte, releasing or consuming a chemical molecule, the concentration of which is detected by the chemical transducer.

Existing fiber optic chemical sensors utilizing these techniques have a number of practical limitations in various applications which may lead to unreliable sensor output.

### BRIEF DESCRIPTION OF THE DRAWINGS

FIG. 1 shows an overall diagram of the disclosed distributed optic fiber sensor system.

FIG. 2 shows a cut-away view of a fiber optic configured as distributed sensor system.

FIG. 3A is a close up view of a fiber optic showing the disclosed mid-fiber segment sensor well.

FIG. 3B is a close up view of a fiber optic showing the disclosed mid-fiber segment sensor well following the re-cladding or coating of the fiber optic segment which has had sensor material embedded into the sensor wells.

FIG. 4A shows an exemplar photodetector output for a luminescent distributed fiber optic sensor fabricated with sensors for measuring pO₂.

FIG. 4B shows an exemplar photodetector output for an absorption-based distributed fiber optic sensor fabricated with sensors for measuring dissolved CO₂ or pCO₂.

FIG. 5A-5C show exemplar photographs of distributed fiber optic sensors.

FIG. 6 shows the response profiles of nitrate fiber sensors.

FIG. 7 shows the response profile of a fiber optic sensor prototype to moisture levels in soil.

### DESCRIPTION

Disclosed is a design for distributed optic fiber sensors and a corresponding method for sensing chemical concentrations with distributed fiber optic sensors, which utilizes segments of optical fiber which incorporate multiple sensing locations along the fiber. The distributed sensors incorporated into the optic fiber generate signals which are simultaneously detected and combined to produce a resultant signal with the effective optic fiber sensor length equal to that of the corresponding fiber segment.

Disclosed is a fabrication process, which in various embodiments includes the laser removal of optic fiber cladding and/or a portion of the core of an optical fiber at precise locations by a directed laser of sufficient energy to cause the specified damage or material removal. The locations of such fiber cladding or core exposure are known as “wells”. In various embodiments, the creation of a sequence of such wells with stripped cladding along a selected segment of the fiber are referred to as a sensorized segment of the optic fiber. In various embodiments, as determined according to a given application, the depth of the wells in the fiber cladding or core, their number, the distance between them, and the length of the sensorized segment may be calibrated and optimized for the most effective sensor output and requirements according to the application. In various embodiments, the optimal well placement and depth may be determined by empirical results or modelling.

In various embodiments, the fiber optic sensor wells are subsequently filled with a suitable chemically sensitive material (or two materials for some biosensors), such that the location of that material is in the path of light radiation transmitted through the optic fiber. In various embodiments, luminescence based fiber optics or sensors are utilized. For embodiments with such luminescence-based fiber optics or sensors, a light source excites the fluorescence of the dye-doped polymer in the multiple wells along the fiber optic. The embedded sensor material in such wells transforms the light signal according to its sensor properties, the source light signal into a light radiation emission which is propagated into and along the core of the optic fiber. This transformed portion of a signal corresponding to the interaction with any particular sensor well is propagated by the optic fiber and recorded at the end of the fiber by a suitable photodetector sensor.

In various embodiments, the disclosed distributed optic fiber sensors and signal detection may be coupled with various methods for phase-resolved luminescence detection. In various embodiments, this combination of distributed fiber optic sensor and phase-resolved luminescence detection provide a capability for effective sensor output calibrated by indirect emission life time measurements.

The main challenge for interrogating luminescent sensor coatings attached to an optical fiber is maintaining repeatable, well-calibrated readings. Emission intensity measurements are affected by fluctuations in the excitation source intensity and the detector response, dimensions of the optical fibers, mechanically-induced variations in fiber transmission, and variation in the thickness of the sensor element. In contrast, time domain measurements that rely on the fluorescence lifetime (the emission kinetics results in a delay between the arrival of the excitation light and emission of photons by the indicator dye), are insensitive to these interferences (as long as a minimum level of light is transmitted), making it a reliable, stable measurement. This is because while the alignment, dimension of the fiber and amount of coating will affect the intensity, it will not affect the emission lifetime.

The direct determination of luminescence decay kinetics or emission lifetime requires complex and costly instrumentation. However, comparatively simple, compact, and inexpensive phase-resolved luminescence measurement equipment can indirectly determine the emission lifetime. In phase-resolved measurements, the instrument generates a continuous sinusoidal waveform at a programmable known frequency that modulates the light illuminating the indicator on the fiber. As a result, the luminescence signal from the indicator dye is intensity modulated at the same frequency as the excitation source. However, because of the finite lifetime of the dye's excited state, there is a phase delay between the excitation signal and the sensor signal. An estimate of the fluorescence lifetime of the indicator can then be computed by measuring the phase (φ) shift between the excitation and sensor signals (tan φ=2πfτ), where f is the modulation frequency and τ is the emission lifetime of the probe.

In various embodiments, for absorption based sensors, the light source is placed at one end of the fiber and a photodetector is located and the other end of the fiber, and the absorption of light by the sensor material can be monitored. Since the indicator-doped polymer is located directly in the core of the fiber, the interaction with propagating light has been experimentally determined and found to be markedly effective.

Because the use of indicators in the sensitive material, the absortion change due to the presence of the target chemical occurs at a particular wavelength, which correspond to the absortion band of the indicator dye. Light at wavelengths far from the absorbance peak of the indicator dye are unaffected by the presence of the target chemical. This allows the system to be self-referenced: by launching and detecting light at two wavelengths, one near the indicator's maximum absorbance and one far from the absorbance band, the system can easily differentiate between spurious signals such as from fiber bending or temperature-induced refractive index changes (which affect both wavelengths) and permeation of the target chemical which only affects one wavelength.

In embodiments utilizing luminescent optical fiber chemical sensors, the sensing element is a chemically-sensitive material in which a specific luminescent indicator molecule has been immobilized in a polymer substrate (dye-doped polymer or sensitive material). In these embodiments, the response to a selective interaction between the target analyte (O₂, CO₂, humidity or pH) and the indicator, the luminescence of the sensitive material, undergoes a measurable change in proportion to the analyte concentration.

The disclosed method of designing distributed sensors is to create segments of optical fiber incorporating multiple sensing spots, which produce signals that are simultaneously detected and combined to produce in effect the output of a single sensing element, with length equal to that of the fiber segment. In our fabrication process, the cladding and core of an optical fiber are precisely removed at multiple spots by means of a laser beam, creating a sequence of wells along a selected segment of the fiber, which we refer to as a sensorized segment.

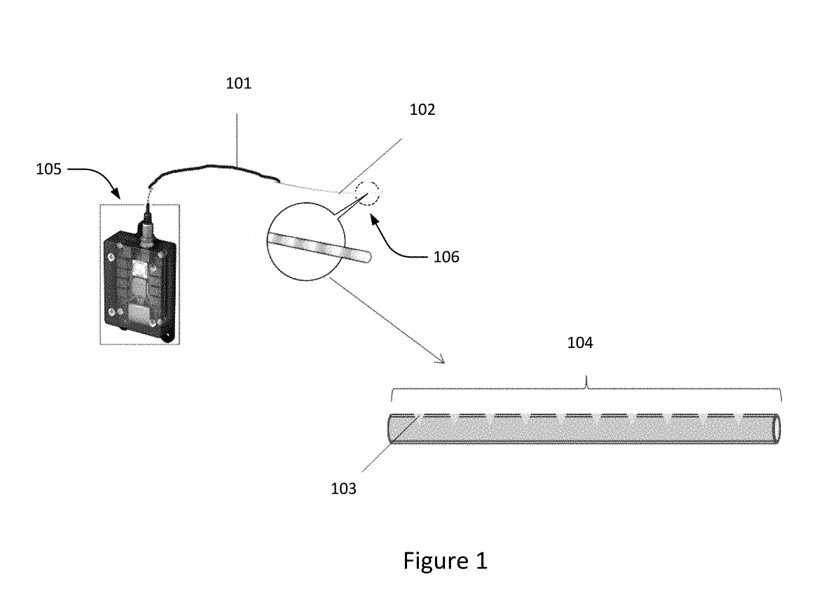

FIG. 1 shows an overall view of the sensor system which includes a luminescence generation component and photodetector component 105 and the distributed sensor fiber optic 101. Close up views 106 and 104 of the fiber are shown. A fiber segment 104 including the distributed sensor well 101 is shown.

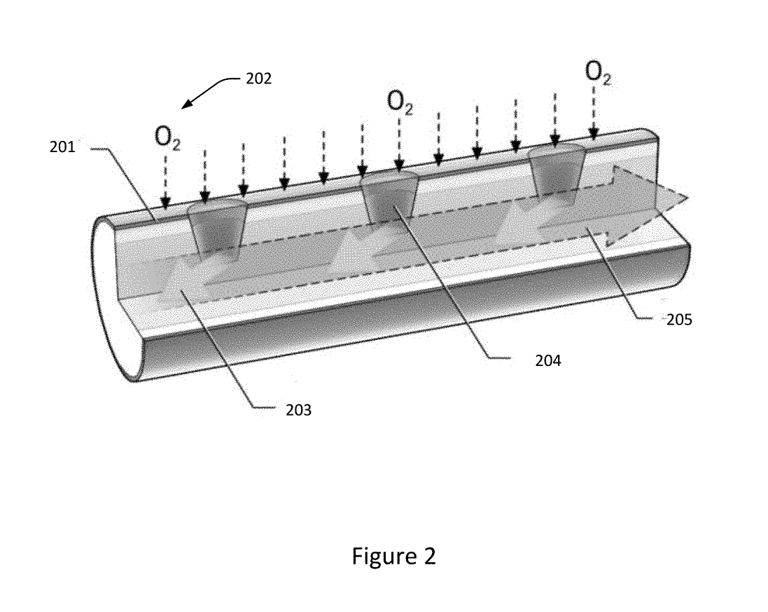

FIG. 2 shows a cut-away close up view of an embodiment of the distributed sensor optic fiber. In this exemplar embodiment, concentrations of oxygen are to be measured 202. In this exemplar embodiment, the sensor well 204 has been cut through the fiber optic cladding 201 and into the fiber core 204. In this embodiment, the sensor material has been filled into the distributed wells, including 204. As shown for this embodiment, the light propagating down the fiber 205 interacts with the distributed sensor material 204 as it passes each well 204. Based on the irradiation of the sensor chemical in the well, the incident light from the source is transformed to a different wavelength and propagated back towards the source and photodetector sensor 203.

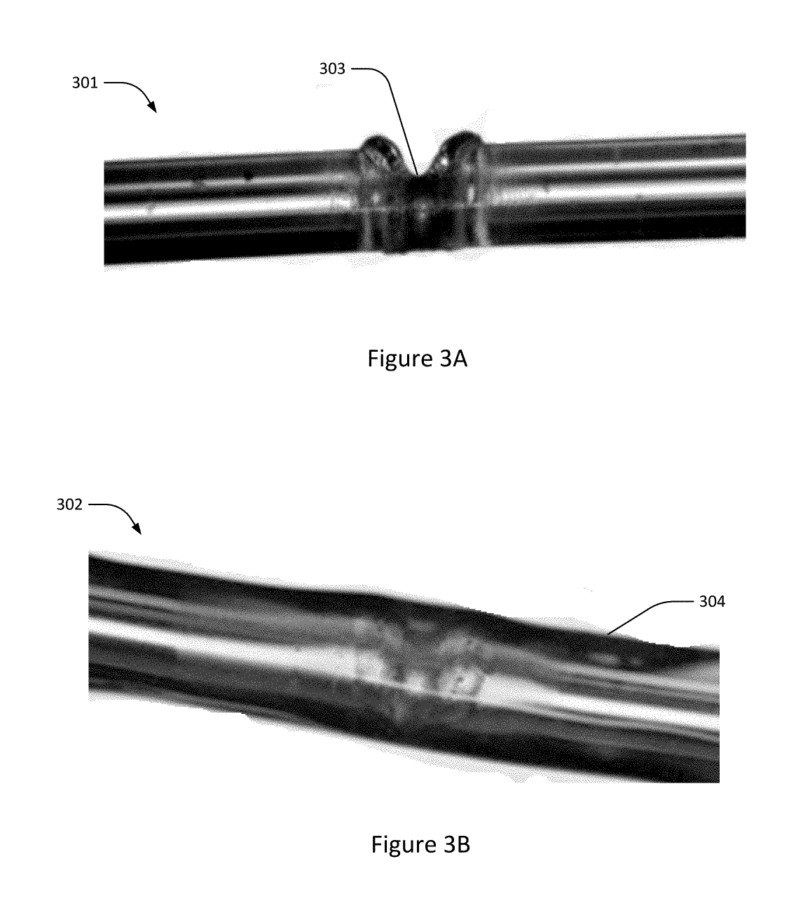

FIGS. 3A and 3B depict actual optic fibers 301 after formation of the sensor well 304 in the fiber 303, and after embedment of the sensor material into the well and a new cladding of the fiber 302.

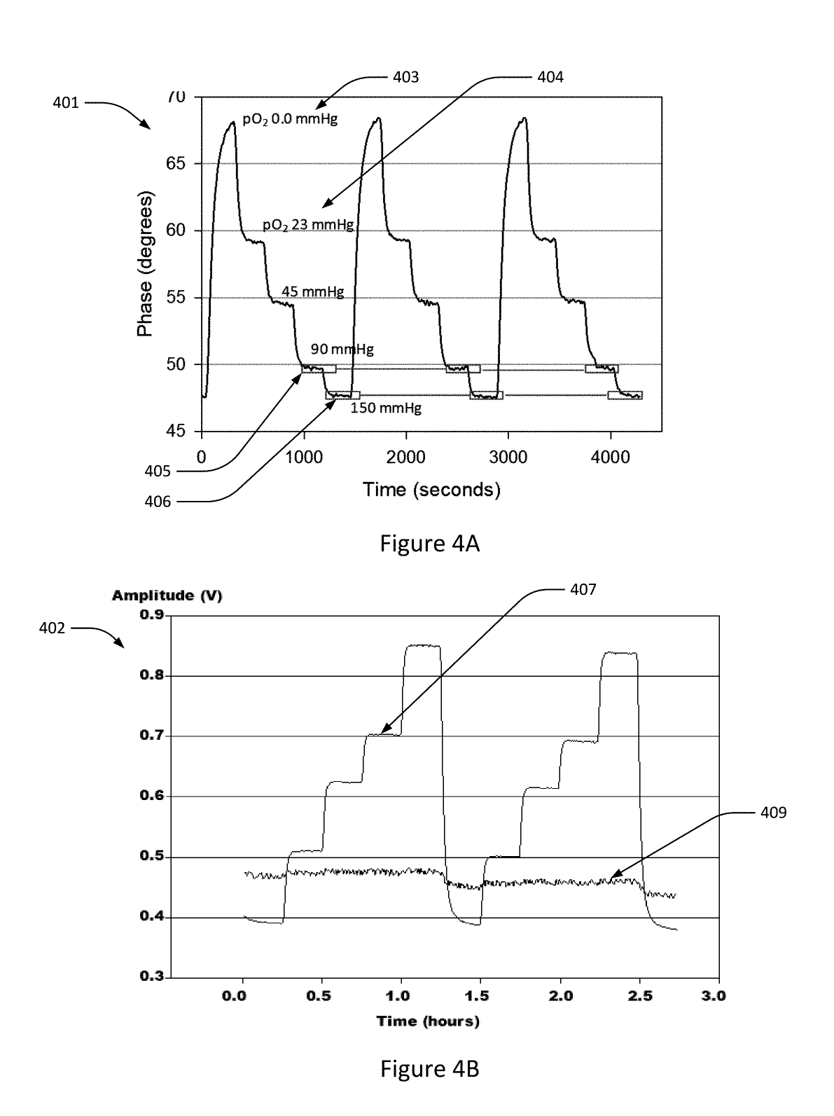

FIGS. 4A and 4B show exemplar photodetector signal readings during active sensor measurement from an embodiment of the disclosed distributed sensor. FIG. 4A shows an exemplar reading of a signal over time 401 for a distributed sensor fiber which has distributed sensor well embedded with a 02 luminescent sensitive material. In this exemplar embodiment, the distributed sensor wells have been calibrated and show pO₂ levels of 0.0 mmHG 403, 23 mmHG 404, 45 mmHG, 90 mmHG 405, 150 mmHG 406.

FIG. 4B shows a similar time based photodetector signal output 402 from the distributed sensor showing the signal plateaus 407 created by the sensed CO₂. A reference signal is shown 409. For these absorption-based sensor embodiments two light sources centered at 590 nm and at 800 nm, respectively, are used. The presence of CO2 only affects the transmission of light at 590 nm, maximum of absorption of the indicator dye embedded in the polymer used for re-coating. The presence of CO2 does not affect the transmission of light at 800 nm, which is used as a reference to correct any affect in the light transmission not caused by the presence of CO2.

For the sensor embodiments which are designed for measurement of pO₂ and pCO₂ with the detection signals shown in FIGS. 4A and 4B, the fiber optic chemical sensors are based on dye-doped polymers specifically formulated for each gas, and distributed along a segment of an optical fiber. The fabrication method involved drilling multiple wells in a segment of an optical fiber with a laser beam, and subsequently refilling the wells with dye-doped polymers, creating a sequence of sensor spots over a length of 10 to 200 mm.

In this particular exemplar embodiment, the number of wells (sensor spots) and their distribution in the fiber were tuned to cover the desired length of fiber. All sensor spots distributed along the fiber segment are excited simultaneously, and their emission is integrated, creating a sensor element 10 to 200 mm long. The embodiment design selected to perform a test in animal models consisted of 5 sensor spots distributed along 10 mm of fiber segment (there are no wells along the rest of the fiber) using 250 um outside diameter, polystyrene core, and PMMA (polymethyl-methacrylate)-clad fibers. In this exemplar embodiment, a simple protocol was utilized for coating the fiber segment with the sensing materials formulated for 02.

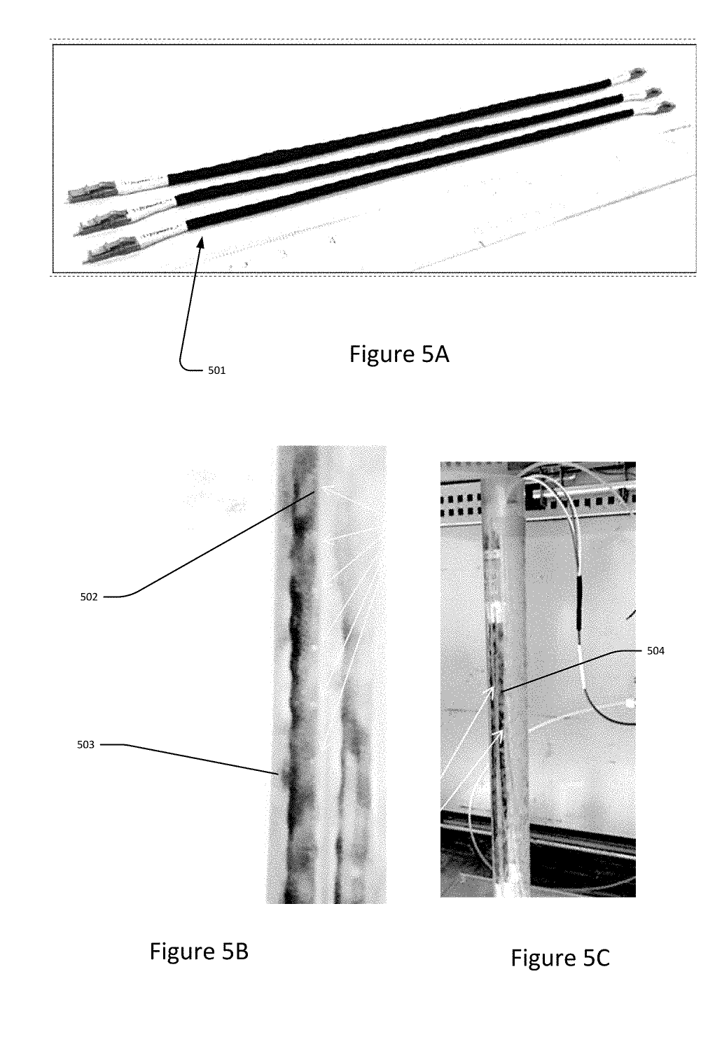

FIGS. 5A-C show photographs of the aforementioned experimental prototypes of the distributed fiber optic sensors.

In various embodiments of the disclosed process and sensor apparatus, the depth of the wells, their number, the distance between them, and the length of the sensorized segment can be tuned according to the sensor application. The wells are subsequently filled with the sensitive material, which places that material in the path of the light transmitted through the fiber. A light source excites the fluorescence of the dye-doped polymer in the multiple wells, whose emission is transferred into the core of the fiber and recorded at the end of the cable via a photodetector.

An exemplar design of the disclosed distributed sensors has been evaluated for measurement range, sensitivity, precision, and response time, by immersion in a saline solution. The evaluation of this embodiment included a compact phase-resolved detector, the See Phase 400, for luminescence sensors and a compact fiber-optic transmission detector, FIRIS, for absorption-based sensors, which served as the readout units. The See Phase 400 and the FIRIS unit are designed to interrogate multiple luminescent sensors simultaneously, reducing the cost of the final monitoring system. Tests were conducted over a range of temperature conditions, to establish the calibration functions (pO₂ vs. phase and DCO₂ vs. amplitude). FIGS. 4A and 4B shows a typical response profile of an O₂ sensor when exposed to varying levels of O₂, after being sterilized with alcohol, and a CO₂ sensor exposed to varying partial pressure of CO₂. In various testing of the exemplar distributed sensor, results demonstrated reversibility and repeatability (precision). Response time tests were conducted in gas phase to avoid the time needed for water equilibration observed during calibration tests.

As noted, optical fibers with distributed sensor wells propagates light from a light source to the sensor well elements and then from the sensing elements to the photodetectors. It also serves as support for the sensing well elements and enables the spatial distribution of such sensor wells.

In other embodiments, the distributed fiber optic sensor is embedded into a nitrogen and carbon oxides sensor cable (NOCOS). This embodiment is utilized to enhance an understanding of the different processes that take place in complex subsurface systems because these processes serve as the substrate for natural, disturbed and managed terrestrial vegetation systems. Reactive transport models can be used to predict biogeochemical processes in complex subsurface matrixes but the real power of the computational tools will always depend on the capability of populating them with accurate and representative data collected in the field.

The characterization of soil and groundwater chemistry has traditionally been carried out via laboratory analysis of “grabbed” samples—either samples of the soil itself, or gas samples, and groundwater. In situ sensors for monitoring chemical parameters, including nutrients, either in soil and groundwater show numerous limitations. Among these, the most relevant limitations are frequent maintenance and the complexity of covering representative areas with local sensors in non-homogeneous matrixes. Also, no single technology or instrument capable of monitoring several relevant chemical parameters and thus a combination of different instruments and techniques are required to collect multi-parameter information. These limitations are overcome in various embodiments disclosed.

Various embodiments of the fiber optic sensor based cables including NOCOS may be used as a geochemical monitoring system specifically to collect real-time information on key geochemical parameters to simulate biogeochemical processes in complex subsurface matrices with reactive transport models. The nitrogen and carbon oxides sensor cable (NOCOS), at the heart of this system is a distributed multi-analyte chemical sensor element, which are chemically sensitive over their entire length. The NOCOS sensor cable—which can be scores or even hundreds of meters long—can send spatially-averaged measurements of soil and groundwater geochemical parameters over very large areas to a single unattended instrument package. In addition to the sensors for carbon dioxide (and dissolved inorganic carbon) and nitrates, sensors for Fe2+ and Fe3+ and water saturation could be incorporated, measuring parameters that are essential to understanding interactions among gases, water, microbes, and rock soils across spatial scales.

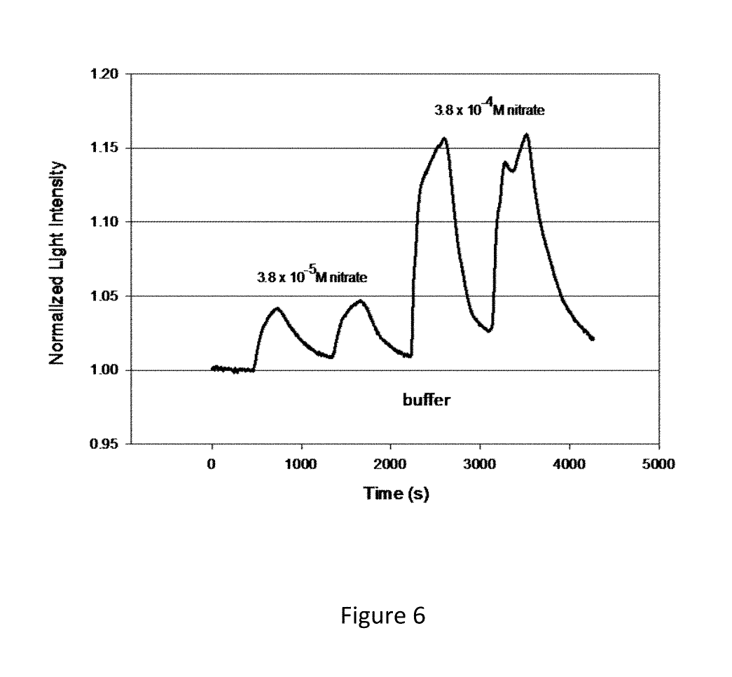

In FIG. 6, response profiles are show to detected three levels of nitrates as indicated by the normalized intensity of the measured light received.

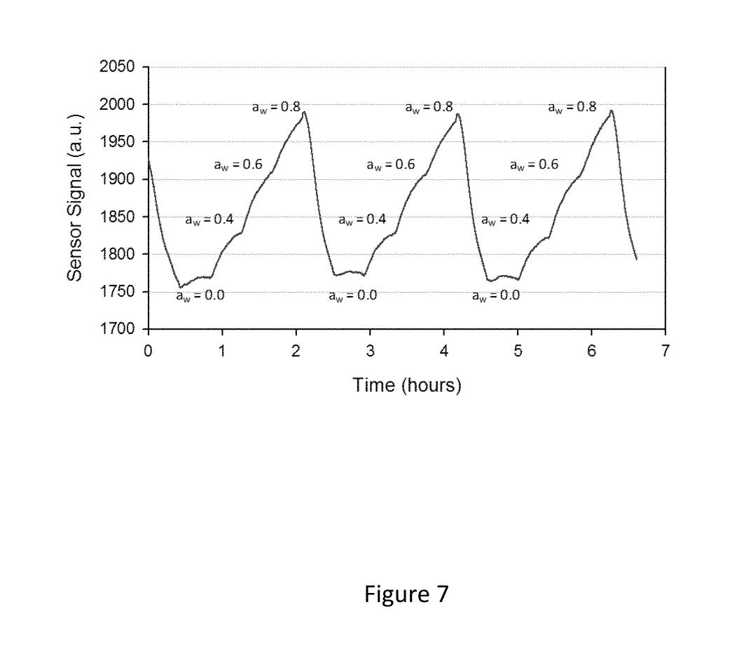

In an alternative embodiment to evanescent field-based fiber optic sensing, a process for fabricating the optical sensors is disclosed, which is referred to as a “multi-spot fiber optic sensor.” The multi-spot sensor fiber is fabricated by drilling multiple wells in the optical fiber with a laser beam, and then refilling the wells with dye-doped polymers sensitive to nitrate (or to Fe or moisture), creating a sequence of sensor spots. In FIG. 7, shown is the response profile of an embodiment fiber optic sensor when exposed to four levels of moisture (water activity) is soil.

What has been described herein is considered merely illustrative of the principles of this invention. Accordingly, it is well within the purview of one skilled in the art to provide other and different embodiments within the spirit and scope of the invention.

What is claimed is:

1. A method for sensing chemical concentrations along an optical fiber comprising:
propagating an optical signal through a core of the optical fiber, wherein the optical fiber is fabricated with a series of wells into at least the cladding of the optical fiber, and wherein the wells have been filled with at least one material sensitive to a target chemical to form sensor wells;
detecting an optical signal which has propagated through the fabricated optical fiber with sensor wells;
processing the detected optical signal to determine chemical concentrations at each of the optical fiber sensor wells.

2. A method for sensing chemical concentrations along an optical fiber as in claim 1 wherein the at least one material is a dye-doped polymer.

3. A method for sensing chemical concentrations along an optical fiber as in claim 1 wherein the at least one material is sensitive to nitrates.

4. A method for sensing chemical concentrations along an optical fiber as in claim 1 wherein the at least one material is sensitive to oxygen.

6. A method for sensing chemical concentrations along an optical fiber as in claim 1 wherein the at least one material is sensitive to pH.

7. A method for sensing chemical concentrations along an optical fiber as in claim 1 wherein the at least one material is sensitive to CO₂.

8. A method for sensing chemical concentrations along an optical fiber as in claim 1 wherein the at least one material is sensitive to humidity.

9. A method for sensing chemical concentrations along an optical fiber as in claim 1 wherein the series of wells are filled with a plurality of materials which are sensitive to biological chemical components.

10. A method for sensing chemical concentrations along an optical fiber as in claim 1 wherein the optical fiber is embedded into a nitrogen oxides and carbon oxides sensor cable.

11. A fiber optic distributed sensor comprising:
an optical fiber wherein the optical fiber is fabricated with a series of wells into at least the cladding of the optical fiber, and wherein the wells have been filled with at least one material sensitive to a target chemical to form sensor wells.

12. A fiber optic distributed sensor as in claim 11 wherein the at least one material is a dye-doped polymer.

13. A fiber optic distributed sensor as in claim 11 wherein the at least one dye-doped polymer is sensitive to nitrates.

14. A fiber optic distributed sensor as in claim 11 wherein at least one material is sensitive to oxygen.

15. A fiber optic distributed sensor as in claim 11 wherein at least one material is sensitive to CO₂.

16. A fiber optic distributed sensor as in claim 11 wherein at least one material is sensitive to humidity.

17. A fiber optic distributed sensor as in claim 11 wherein the series of wells are filled with a plurality of materials which sensitive to biological chemical components.

18. A fiber optic distributed sensor as in claim 11 wherein the optical fiber is embedded into a nitrogen and carbon oxide sensor cable.

19. A system for sensing chemical concentrations along an optical fiber comprising:
the fiber optic sensor as in claim 11;
a light source;
at least one photodetector sensor.

20. A system as in claim 19 wherein the at least one material is a dye-doped polymer.

21. A system as in claim 19 wherein the at least one dye-doped polymer is sensitive to nitrates.

22. A system as in claim 19 wherein at least one material is sensitive to oxygen.

23. A system as in claim 19 wherein the series of wells are filled with a plurality of materials which sensitive to biological chemical components.

24. A system as in claim 19 wherein the optical fiber is embedded into a nitrogen oxides and carbon oxides sensor cable.
